(19) United States
(12) Patent Application Publication
(10) Pub. No.: US 2017/0184899 A1
(43) Pub. Date: Jun. 29, 2017

(54) LIQUID CRYSTAL DISPLAY DEVICE

(71) Applicant: Japan Display Inc., Tokyo (JP)

(72) Inventor: Yoshifumi SAEKI, Tokyo (JP)

(21) Appl. No.: 15/344,657

(22) Filed: Nov. 7, 2016

(30) Foreign Application Priority Data
Dec. 25, 2015 (JP) 2015-253793

(51) Int. Cl. G02F 1/1339; G02F 1/1362; G02F 1/1333; G02F 1/1368

(52) U.S. Cl. CPC G02F 1/13394; G02F 1/1339; G02F 1/1368; G02F 1/136286; G02F 1/133345

(57) ABSTRACT

The first substrate has a first projection in which a first part extending along a side of the first substrate in the peripheral part of the first substrate and a second part extending from the first part towards an edge of the first substrate are formed. Width of a cross section of the first projection is smaller on its tip end's side than on the first substrate's side. The second substrate has a second projection extending along a side of the second substrate in the peripheral part of the second substrate. Width of a cross section of the second projection is smaller on its tip end's side than on the second substrate's side. The second part of the first projection faces the second projection. The seal member exists between the first projection and the second projection.

### CLAIM OF PRIORITY

The present application claims priority from Japanese Patent Application JP 2015-253793 filed on Dec. 25, 2015, the content of which is hereby incorporated by reference into this application.

### BACKGROUND OF THE INVENTION

1. Field of the Invention

The present invention relates to a display device, and in particular, to a liquid crystal display device capable of securing the reliability of a seal part even when a frame region is narrowed.

2. Description of the Related Art

In a liquid crystal display device, a thin-film transistor (TFT) substrate on which pixels each having pixel electrodes, a TFT, etc. are formed like a matrix and a counter substrate are arranged to face each other and a liquid crystal is sandwiched between the TFT substrate and the counter substrate. The liquid crystal display device forms an image by controlling the light transmittance of liquid crystal molecules in regard to each pixel.

Especially with middle-sized and small-sized liquid crystal display devices, there is a strong demand to enlarge the display region while maintaining small exterior size of the display device. Accordingly, the region between the display region and the edge of the liquid crystal display panel, namely, the frame region, becomes narrower and narrower. The liquid crystal is sealed up in a space between the TFT substrate and the counter substrate by use of a seal member formed in the frame region. The seal member is applied by using a dispenser and thereafter hardened by using heat or ultraviolet rays.

With the decrease in the width of the seal member, uniformly forming the seal member becomes difficult and reliability of the seal part becomes an issue. Further, if the seal member before hardening makes contact with the liquid crystal, the seal member can contaminate the liquid crystal and cause a drop in the resistivity of the liquid crystal.

JP-A-2009-133930 describes a configuration in which a line-shaped spacer is formed on the TFT substrate's side and on the counter substrate's side and the line-shaped spacers are arranged in the seal member in order to secure an appropriate width of the seal member. JP-A-2004-133194 describes a configuration in which an anti-diffusion wall is formed to reduce the area of contact between the seal member and the liquid crystal. JP-A-2013-190551 describes a configuration in which an inner projection and an outer projection are respectively arranged along the inner edge and the outer edge of the seal member in order to precisely determine the distance between the TFT substrate and the counter substrate.

### SUMMARY OF THE INVENTION

The demand for narrowing the frame region is growing, and accordingly, decreasing the width of the seal member is also being demanded. However, with the decrease in the width of the seal member, variations in the application of the seal member can cause extremely narrow parts of the seal member or interruption of the seal member depending on the case. Further, due to the narrow frame region, locally widened parts of the seal member can protrude into the display region.

With the increase in the screen resolution, abnormality such as color irregularity due to variations in the distance between the TFT substrate and the counter substrate becomes more likely to occur. Such variations in the distance between the TFT substrate and the counter substrate can occur also in the seal part. Then, the influence of the variations can reach the display region and deteriorate the image quality in peripheral parts of the screen.

Recently, the liquid dropping method is commonly used as the method for injecting the liquid crystal into the internal space of the liquid crystal display panel. In this method, the liquid crystal is dropped into the internal space before the seal member hardens. Thus, the liquid crystal, making contact with the seal member before hardening, is likely to be contaminated by the seal member. The object of the present invention is to secure the reliability of the seal part, restrain the deterioration in the image quality in the peripheral parts of the display region, and reduce the degradation of the liquid crystal due to the influence of the seal member even when the frame region is narrowed.

The present invention solves the problems described above, and its specific solution is as follows.

In accordance with an aspect of the present invention, there is provided a liquid crystal display device including a first substrate and a second substrate bonded to each other at their peripheral parts by using a seal member and a liquid crystal sealed up in a space between the first substrate and the second substrate. The first substrate has a first projection in which a first part extending along a side of the first substrate in the peripheral part of the first substrate and a second part extending from the first part towards an edge of the first substrate are formed. Width of a cross section of the first projection is smaller on its tip end's side than on the first substrate's side. The second substrate has a second projection extending along a side of the second substrate in the peripheral part of the second substrate. Width of a cross section of the second projection is smaller on its tip end's side than on the second substrate's side. The second part of the first projection faces the second projection. The seal member exists between the first projection and the second projection.

### BRIEF DESCRIPTION OF THE DRAWINGS

FIG. 1 is a plan view showing an example of a liquid crystal display device to which the present invention is applied.

FIG. 2A is a schematic diagram showing problems occurring when the width of a seal part is reduced.

FIG. 2B is a schematic diagram showing another problems occurring when the width of a seal part is reduced.

FIG. 3 is a plan view showing a liquid crystal display device according to a first embodiment of the present invention.

FIG. 4 is a perspective view showing the relationship between a first projection and a second projection.

FIG. 5 is an enlarged plan view of the part A in FIG. 3.

FIG. 6 is a cross-sectional view taken along the line A-A in FIG. 5.

FIG. 7 is a cross-sectional view taken along the line B-B in FIG. 5.

FIG. 8A is a schematic plan view showing a process for carrying out the present invention in a counter substrate.

FIG. 8B is a schematic plan view showing a process for carrying out the present invention in a TFT substrate.

FIG. 9A is a schematic plan view showing another process for carrying out the present invention in a counter substrate.

FIG. 9B is a schematic plan view showing another process for carrying out the present invention in a TFT substrate.

FIG. 10 is a cross-sectional view showing another example of the liquid crystal display device according to this embodiment.

FIG. 11 is a cross-sectional view showing still another example of the liquid crystal display device according to this embodiment.

FIG. 12 is a plan view showing a liquid crystal display device according to a second embodiment of the present invention.

FIG. 13 is a perspective view showing the relationship between a first projection and second projections in the second embodiment.

FIG. 14 is an enlarged plan view of the part B in FIG. 12.

FIG. 15 is a cross-sectional view taken along the line C-C in FIG. 14.

FIG. 16 is a cross-sectional view taken along the line D-D in FIG. 14.

FIG. 17 is a plan view showing a liquid crystal display device according to a third embodiment of the present invention.

FIG. 18 is a perspective view showing the relationship between a first projection and a second projection in the third embodiment.

FIG. 19 is an enlarged plan view of the part C in FIG. 17.

FIG. 20 is a cross-sectional view taken along the line E-E in FIG. 19.

FIG. 21 is a cross-sectional view taken along the line F-F in FIG. 19.

### DESCRIPTION OF THE PREFERRED EMBODIMENTS

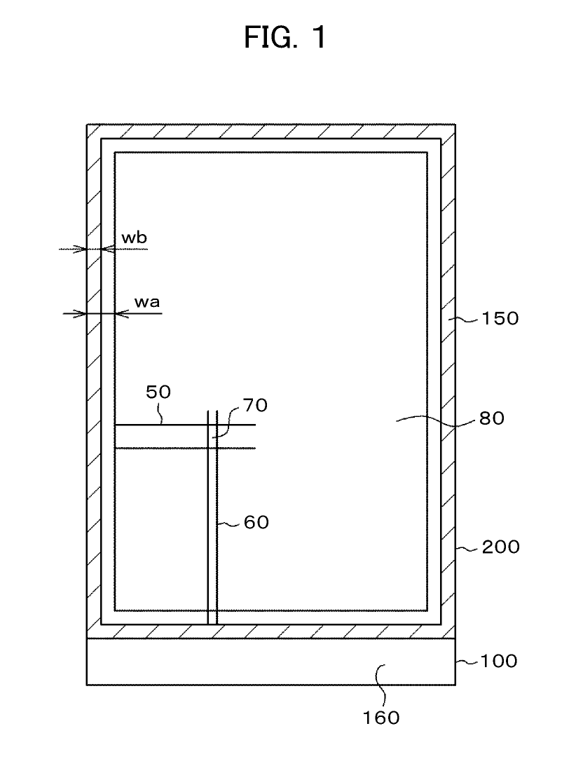

FIG. 1 is a plan view showing an example of a liquid crystal display device to which the present invention is applied. In FIG. 1, a TFT substrate 100 on which scan lines 50 and video signal lines 60 have been formed and a counter substrate 200 are bonded to each other with a seal member 150 formed in a peripheral part, and a liquid crystal is held in a space between the TFT substrate 100 and the counter substrate 200. A display region 80 is formed in a part where the TFT substrate 100 and the counter substrate 200 overlap each other, and a frame region is formed outside the display region 80.

The TFT substrate 100 is formed to be larger than the counter substrate 200. A part of the TFT substrate 100 not paired with the counter substrate 200 is formed as a terminal unit 160. In the terminal unit 160, terminals for supplying scan signals, video signals, electric power, etc. to the display region 80 are formed and an IC driver for driving the liquid crystal is arranged. Further, a so-called flexible wiring board is connected to the terminal unit 160 in order to supply signals and electric power from the outside.

In the display region 80 shown in FIG. 1, a plurality of scan lines 50 extending in a horizontal direction are arranged in a vertical direction. Further, a plurality of video signal lines 60 extending in the vertical direction are arranged in the horizontal direction. The scan signals, video signals, etc. are supplied from the terminal unit 160. Each pixel 70 is formed as a region surrounded by scan lines 50 and video signal lines 60. Each pixel 70 includes a TFT and pixel electrodes. In recent years, narrowing the frame region is being demanded and the width wa shown in FIG. 1 has decreased to approximately 0.5 mm. Accordingly, the seal member 150 formed in the frame region is also being narrowed and the width wb shown in FIG. 1 has decreased to approximately 0.3 mm.

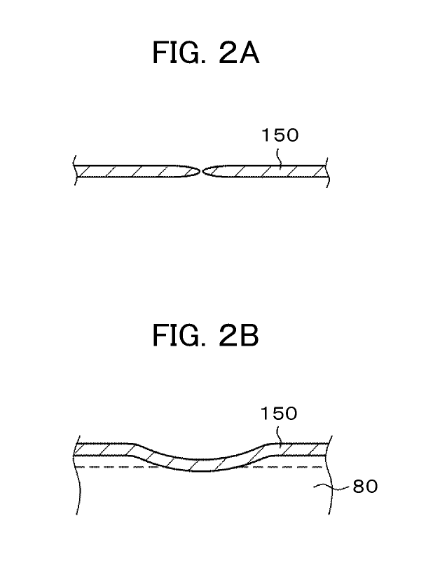

While the seal member 150 is applied by using a dispenser, variations in the application greatly affects the reliability of the seal part in cases where the width of the seal member 150 is reduced. FIG. 2A shows an example in which a part of the seal member 150 has narrowed and interrupted. Although such interruption never occurs if the width of the seal member 150 is originally large, the phenomenon like that shown in FIG. 2A is caused by the reduction in the width of the seal member 150.

FIG. 2B shows an example in which the position of applying the seal member 150 fluctuated in a certain part, the width of the seal member 150 increased in the part, and the seal member 150 protruded into the display region 80. Such a phenomenon hardly occurs when the frame region is wide. However, the narrowing of the frame region has facilitated the occurrence of the phenomenon. Incidentally, while there are cases where the seal member is applied by means of printing or the like, similar problems occur even in such cases. One of the objects of the present invention is to prevent such phenomena. Embodiments according to the present invention will be described in detail below.

### First Embodiment

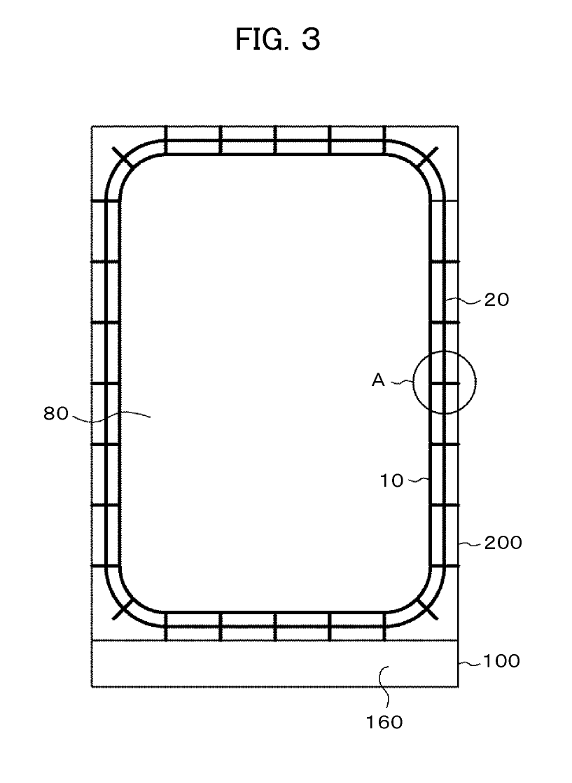

FIG. 3 is a schematic plan view showing a liquid crystal display device according to a first embodiment of the present invention. In FIG. 3, the counter substrate 200 is arranged over the TFT substrate 100 and the liquid crystal is sealed up in a space between the TFT substrate 100 and the counter substrate 200. On the counter substrate 200's side of the seal part, a projection 10, having parts in T-shapes in the plan view, is formed throughout the periphery of the counter substrate 200. This projection 10 will hereinafter be referred to as a “T-shaped projection 10” since the projection 10 has parts in T-shapes in the plan view. On the TFT substrate 100's side, a projection 20 is formed like a frame in the peripheral part of the TFT substrate 100. This projection 20 will hereinafter be referred to as a “frame-shaped projection 20.” Illustration of the seal member is omitted in FIG. 3 to avoid complication of the drawing.

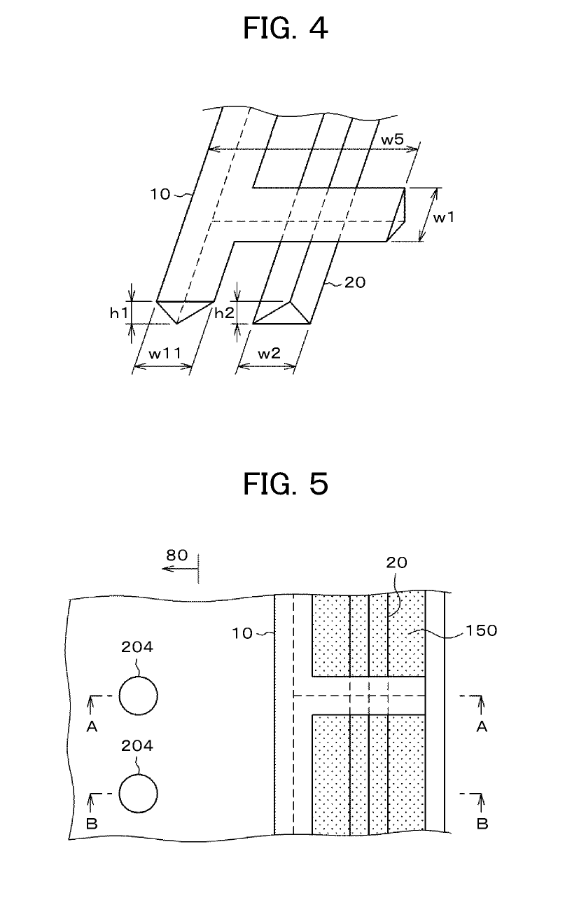

FIG. 4 is a perspective view of the part A in FIG. 3. Illustration of the seal member is omitted in FIG. 4 to facilitate the understanding of the drawing. In FIG. 4, the T-shaped projection 10 is formed on the counter substrate 200's side and the frame-shaped projection 20 is formed on the TFT substrate 100's side. Both of the T-shaped projection 10 and the frame-shaped projection 20 have triangular cross sections. The T-shaped projection 10 and the frame-shaped projection 20 are in contact with each other at apices of their triangles. In FIG. 4, the sum h1+h2 of the height h1 of the T-shaped projection 10 and the height h2 of the frame-shaped projection 20 equals the distance between the TFT substrate 100 and the counter substrate 200. The heights h1 and h2 satisfy h1=h2 in many cases. In such cases, suppose the distance between the TFT substrate 100 and the counter substrate 200 is 3 μm, each of h1 and h2 is approximately 1.5 μm. As above, the T-shaped projection 10 and the frame-shaped projection 20 also have the function of spacers in the seal part.

The width of a base part of each of the T-shaped projection 10 and the frame-shaped projection 20 will hereinafter be referred to simply as “width.” The width w11 of a part of the T-shaped projection 10 extending in a direction parallel to a side of the counter substrate 200, the width w1 of a part of the T-shaped projection 10 extending in a direction orthogonal to the side of the counter substrate 200, and the width w2 of the base part of the frame-shaped projection 20 (hereinafter referred to simply as “widths”) are approximately 15 μm, for example. Since the width of the seal member is approximately 300 μm, the widths w1, w11 and w2 are negligible in comparison with the width of the seal member. Incidentally, the width w5 of the T-shaped projection 10 measured in the direction orthogonal to the side of the counter substrate 200 can be approximately equal to or smaller than the width of the seal member. Both the T-shaped projection 10 and the frame-shaped projection 20 can be formed in precise dimensions since the projections 10 and 20 are formed by means of photolithography.

FIG. 5 is a plan view of the part A in FIG. 3. In FIG. 5, the part A is viewed from the counter substrate 200's side. The T-shaped projection 10 is formed on the counter substrate 200's side, while the frame-shaped projection 20 is formed on the TFT substrate 100's side. The dotted line at the center of the T-shaped projection 10 indicates the top apex of the triangle of the T-shaped projection 10. The dotted line is used since the top apex of the triangle is situated on the back side in the plan view. The line at the center of the frame-shaped projection 20 indicates the top apex of the triangle of the frame-shaped projection 20. The seal member 150 is filled in between the T-shaped projection 10 and the frame-shaped projection 20. The left-hand side of FIG. 5 is the display region 80, in which columnar spacers 204 for maintaining the distance between the TFT substrate 100 and the counter substrate 200 are formed.

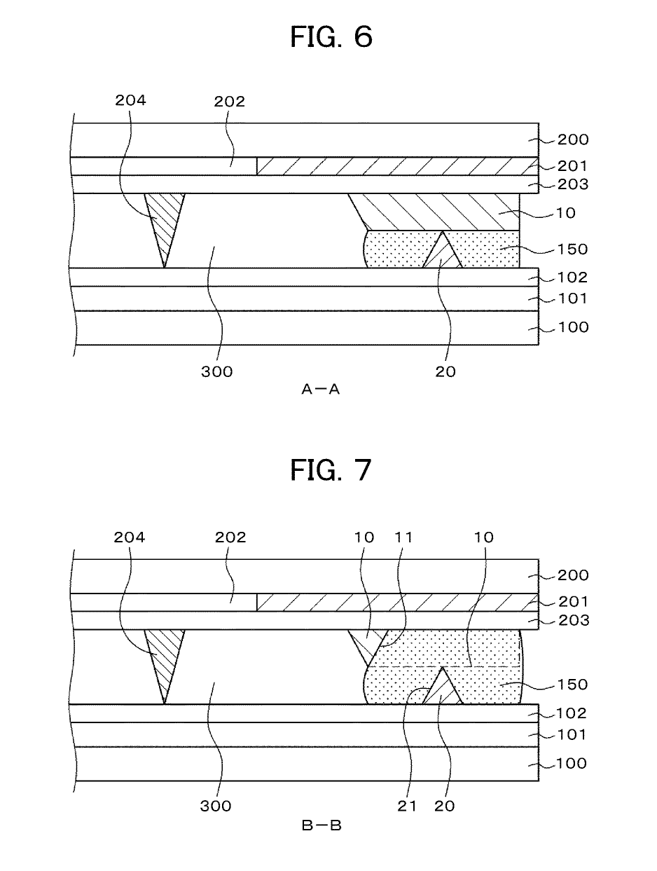

FIG. 6 is a cross-sectional view taken along the line A-A in FIG. 5. In FIG. 6, an organic passivation film 101 is formed on the TFT substrate 100. The organic passivation film 101 is formed with transparent resin such as acrylic, for example. While other layers such as TFTs and an insulation film are formed under the organic passivation film 101, such layers are omitted in FIG. 6 to avoid complication of the drawing. The organic passivation film 101 is used not only to protect the TFTs but also as a planarization film, and thus is formed to be as thick as approximately 1-4 μm. An inorganic insulation film 102 is formed on the organic passivation film 101. The frame-shaped projection 20 is formed on the inorganic insulation film 102.

In FIG. 6, the counter substrate 200 is arranged to oppose the TFT substrate 100. On the counter substrate 200, a black matrix 201 to serve as a light blocking film is formed in the seal part, while color filters 202 are formed in the display region 80. An overcoat film 203 is formed to cover the black matrix 201 and the color filters 202. On the overcoat film 203, the T-shaped projection 10 is formed in the seal part, while the columnar spacers 204 are formed in the display region 80. The TFT substrate 100 and the counter substrate 200 are bonded to each other with the seal member 150.

In FIG. 6, the space on the inside of the seal member 150 is filled with the liquid crystal 300. Although alignment layers are formed on the TFT substrate 100's side and the counter substrate 200's side for the initial alignment of molecules of the liquid crystal 300, the alignment layers are omitted in FIG. 6 to avoid complication of the drawing. As shown in FIG. 6, the distance between the TFT substrate 100 and the counter substrate 200 in the seal part is determined by the T-shaped projection 10 and the frame-shaped projection 20. In the display region 80, the distance is determined by the columnar spacers 204.

In this embodiment, the liquid crystal 300 is fed into the internal space between the TFT substrate 100 and the counter substrate 200 by the liquid dropping method. However, the seal member 150 has not hardened yet when the liquid crystal is dropped. If the liquid crystal 300 makes contact with the seal member 150 not hardened yet, constituents of the seal member 150 can dissolve in the liquid crystal 300 and deteriorate the properties of the liquid crystal. In this embodiment, the area of contact between the seal member 150 and the liquid crystal is reduced by the presence of the T-shaped projection 10 as shown in FIG. 6. Thus, the possibility of the contamination of the liquid crystal by the seal member 150 before hardening is lowered in comparison with the conventional structure.

FIG. 7 is a cross-sectional view taken along the line B-B in FIG. 5. FIG. 7 is identical with FIG. 6 except for the seal part. In FIG. 7, the seal member 150 bonds the TFT substrate 100 and the counter substrate 200 to each other. The dotted line of the T-shaped projection 10 indicates that the T-shaped projection 10 lies behind the illustrated part of the seal member 150. As shown in FIG. 7, the contact area of the seal member 150 is increased by the contact with the slope 11 of the triangle of the T-shaped projection 10 and the contact with the slopes 21 of the triangle of the frame-shaped projection 20, and thus the adhesivity by the seal member 150 can be increased and the reliability of the seal part is improved. The rest of the configuration is identical with that explained referring to FIG. 6.

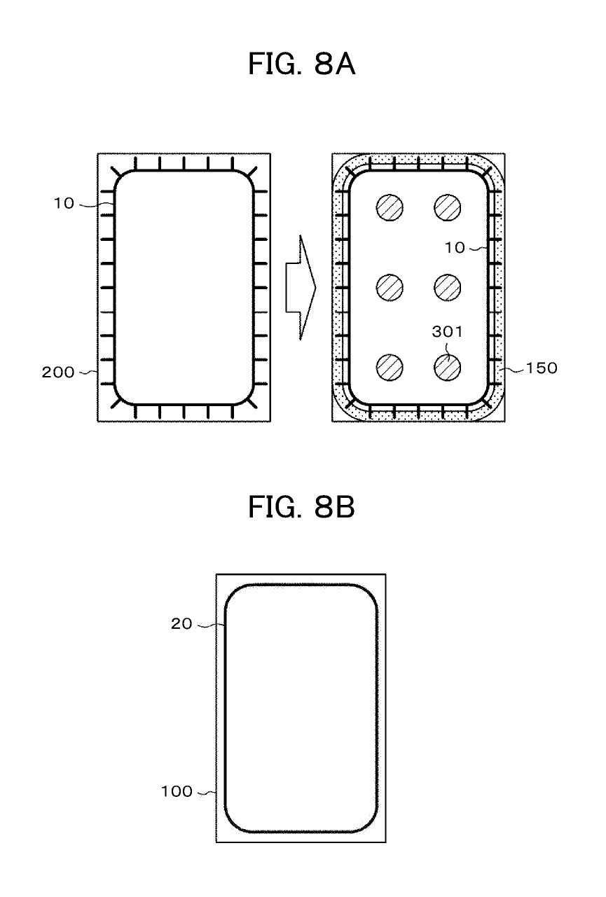

FIGS. 8A and 8B are schematic diagrams for explaining a production method in the present invention by taking the configuration of the first embodiment as an example. FIG. 8A shows the counter substrate 200's side, while FIG. 8B shows the TFT substrate 100's side. In FIG. 8A, the T-shaped projection 10 is formed on the counter substrate 200's side. The T-shaped projection 10 can be formed concurrently with the formation of the columnar spacers in the display region by using the same material. Since the height of the T-shaped projection 10 is less than that of the columnar spacers, the T-shaped projection 10 can be formed by using half exposure technology, for example.

The T-shaped projection 10 can also be formed during the formation of the overcoat film 203, by increasing the film thickness of a part of the overcoat film 203 corresponding to the T-shaped projection 10 compared to other regions by using the half exposure technology. Thereafter, the seal member 150 is applied on the T-shaped projection 10 by using the dispenser. Thereafter, the liquid crystal 301 is dropped into the region surrounded by the T-shaped projection 10. In this state, the seal member 150 has not hardened yet. However, the contamination of the liquid crystal 301 by the seal member 150 can be restrained since the liquid crystal 301 and the seal member 150 are separated from each other by the T-shaped projection 10.

FIG. 8B shows a state in which the frame-shaped projection 20 has been formed on the TFT substrate 100's side. The frame-shaped projection 20 can be formed on the inorganic insulation film 102 with the same material as the organic passivation film 101, for example. However, other organic materials are also usable. The frame-shaped projection 20 can also be formed by increasing the film thickness of a part of the organic passivation film 101 corresponding to the frame-shaped projection 20 compared to other regions by using the half exposure technology.

Thereafter, the TFT substrate 100 and the counter substrate 200 are bonded to each other via the seal member 150. In this case, the seal member 150 is pressed and widened by the T-shaped projection 10 and the frame-shaped projection 20, and thus the interruption of the seal member 150 like that shown in FIG. 2A can be prevented. Further, the protrusion of the seal member 150 into the display region 80 like that shown in FIG. 8B can be restrained by the presence of the T-shaped projection 10. Furthermore, outward protrusion of the seal member 150 can also be restrained thanks to the presence of the frame-shaped projection 20.

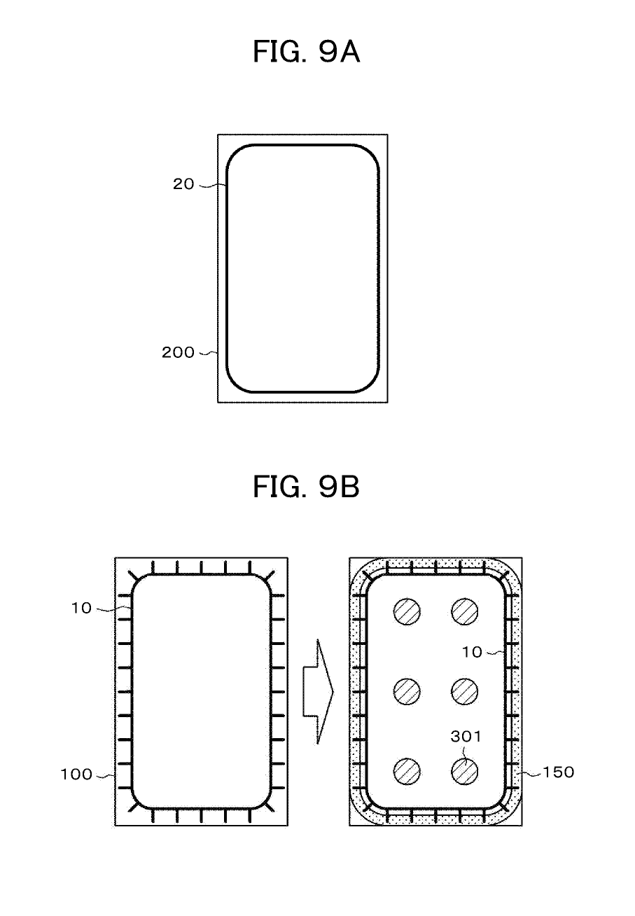

FIGS. 9A and 9B show another example of the production method in the present invention. FIG. 9A shows the counter substrate 200's side, while FIG. 9B shows the TFT substrate 100's side. FIGS. 9A and 9B differ from FIGS. 8A and 8B in that the frame-shaped projection 20 is formed on the counter substrate 200's side and the T-shaped projection 10 is formed on the TFT substrate 100's side in FIGS. 9A and 9B. The T-shaped projection 10 on the TFT substrate 100 can be formed by a method similar to that explained referring to FIGS. 8A and 8B. In FIGS. 9A and 9B, the seal member 150 is formed and the liquid crystal 301 is dropped on the TFT substrate 100's side.

On the other hand, the frame-shaped projection 20 is formed on the counter substrate 200's side. The frame-shaped projection 20 in this example can be formed by a method similar to the formation of the T-shaped projection 10 explained referring to FIGS. 8A and 8B. Thereafter, the TFT substrate 100 and the counter substrate 200 are bonded to each other via the seal member 150. In this case, the seal member 150 is pressed and widened by the T-shaped projection 10 and the frame-shaped projection 20, and thus the interruption of the seal member 150 like that shown in FIG. 2A can be prevented. Further, the protrusion of the seal member 150 into the display region 80 like that shown in FIG. 2B can be restrained by the presence of the T-shaped projection 10. Furthermore, outward protrusion of the seal member 150 can also be restrained thanks to the presence of the frame-shaped projection 20.

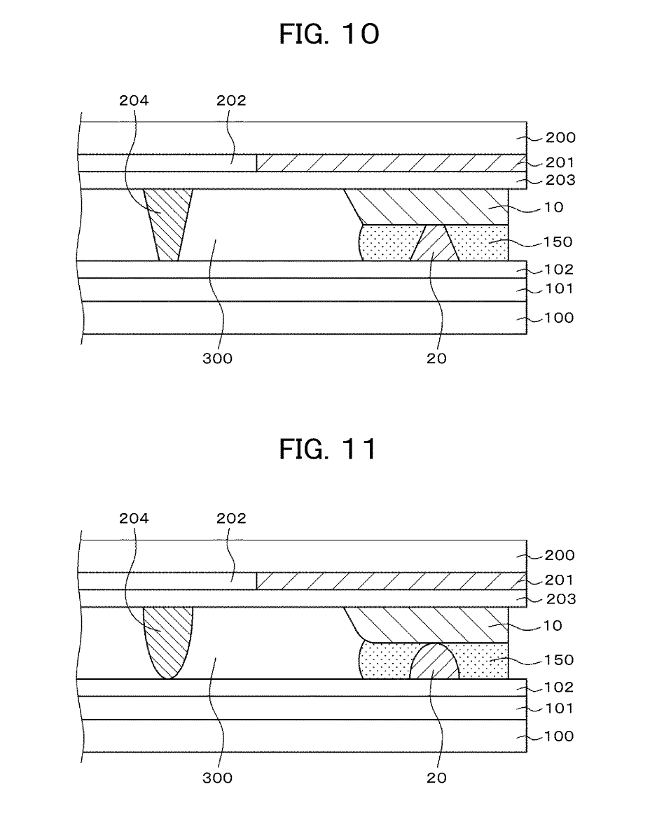

While the above explanation has been given assuming that the cross sections of the T-shaped projection 10, the frame-shaped projection 20, the columnar spacer 204, etc. are in triangular shapes, the present invention is not to be restricted to such examples. FIG. 10 shows a case where the cross sections of the T-shaped projection 10, the frame-shaped projection 20, the columnar spacer 204, etc. are in trapezoidal shapes. Also in this case, the effects described above can be achieved. FIG. 11 shows a case where the cross sections of the T-shaped projection 10, the frame-shaped projection 20, the columnar spacer 204, etc. are in tongue-like shapes. Also in this case, similar effects can be achieved.

### Second Embodiment

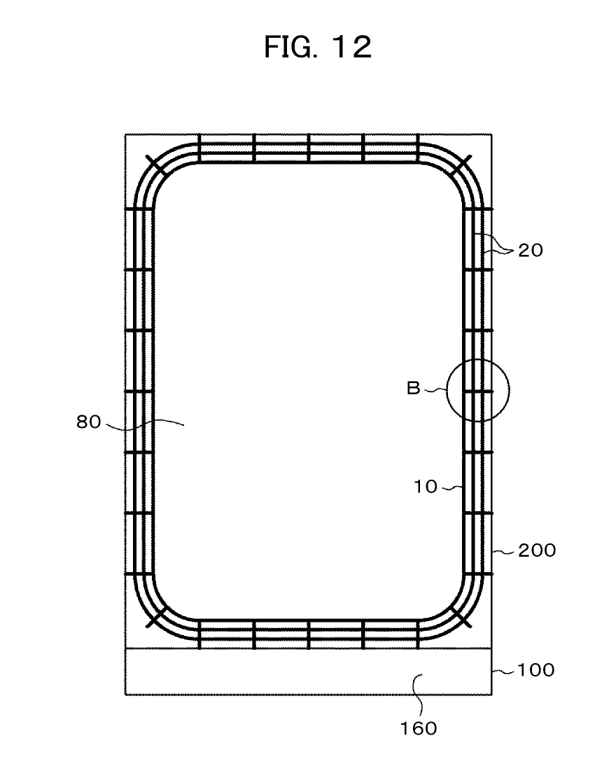

FIG. 12 is a schematic plan view showing a liquid crystal display device according to a second embodiment of the present invention. FIG. 12 differs from FIG. 3 in the first embodiment in that two frame-shaped projections 20 are formed in parallel on the TFT substrate 100's side. By forming two frame-shaped projections 20, the seal member 150 can be widened more uniformly when the TFT substrate 100 and the counter substrate 200 are bonded to each other. The rest of the configuration is similar to that explained referring to FIG. 3.

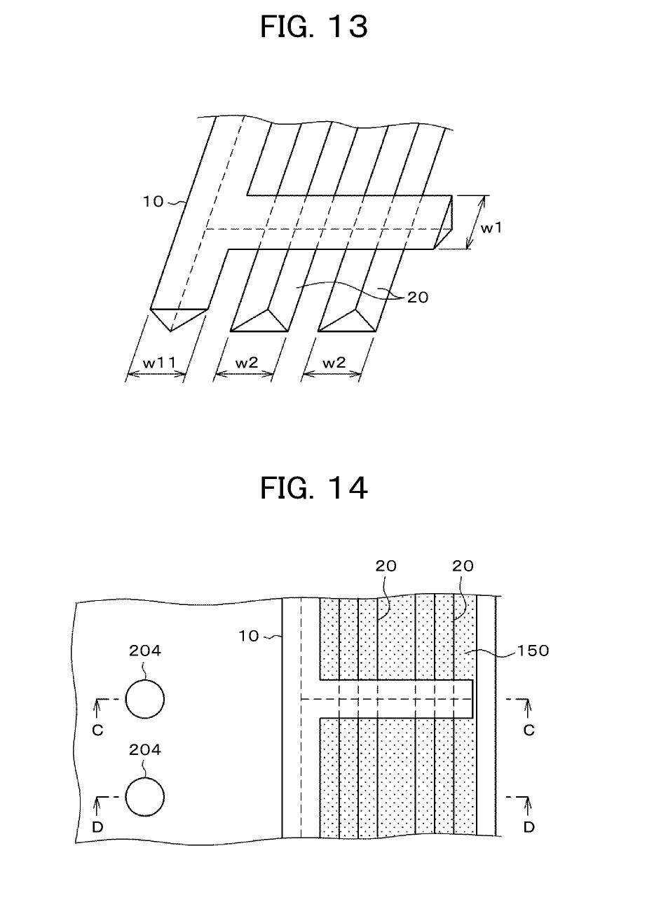

FIG. 13 is a perspective view of the part B in FIG. 12. Illustration of the seal member is omitted in FIG. 13 to facilitate the understanding of the drawing. FIG. 13 differs from FIG. 4 in the first embodiment in that two frame-shaped projections 20 are formed on the TFT substrate 100's side. Further, top apices of the triangles of the two frame-shaped projection 20 are in contact with the top apex of the triangle of the T-shaped projection 10. In FIG. 13, the widths w1 and w11 of the T-shaped projection 10 and the width w2 of each of the two frame-shaped projections 20 are 15 μm similarly to those explained referring to FIG. 4. The height h1 of the T-shaped projection 10 and the height h2 of the frame-shaped projection 20 are also set similarly to those explained referring to FIG. 4.

FIG. 14 is a plan view of the part B in FIG. 12. In FIG. 14, the part B is viewed from the counter substrate 200's side. FIG. 14 differs from FIG. 5 in the first embodiment in that two frame-shaped projections 20 are formed on the TFT substrate 100's side. The width of the seal member 150 is approximately 300 μm, whereas the width of each frame-shaped projection 20 is approximately 15 μm, and thus there is no problem in terms of space even if two frame-shaped projections 20 are arranged. The rest of the configuration is similar to that in FIG. 5.

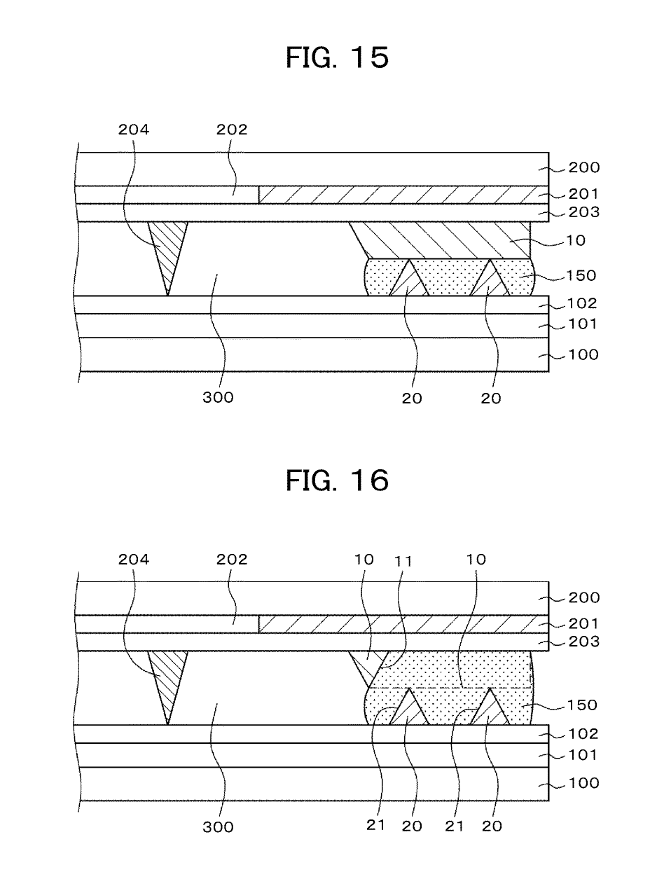

FIG. 15 is a cross-sectional view taken along the line C-C in FIG. 14. FIG. 15 differs from FIG. 6 in the first embodiment in that two frame-shaped projections 20 are formed in parallel and each of the frame-shaped projections 20 is in contact with the T-shaped projection 10. With the presence of two frame-shaped projections 20, the distance between the TFT substrate 100 and the counter substrate 200 in the seal part can be maintained more stably.

FIG. 16 is a cross-sectional view taken along the line D-D in FIG. 14. FIG. 16 differs from FIG. 7 in the first embodiment in that two frame-shaped projections 20 are in contact with the T-shaped projection 10. As shown in FIG. 16, the slopes 21 of the triangles of the two frame-shaped projections 20 and the slope 11 of the triangle of the T-shaped projection 10 are bonded to the seal member 150, and thus the adhesion strength of the seal member 150 can be increased further in comparison with the first embodiment.

The rest of the configuration and effects of this embodiment are equivalent to those explained in the first embodiment.

### Third Embodiment

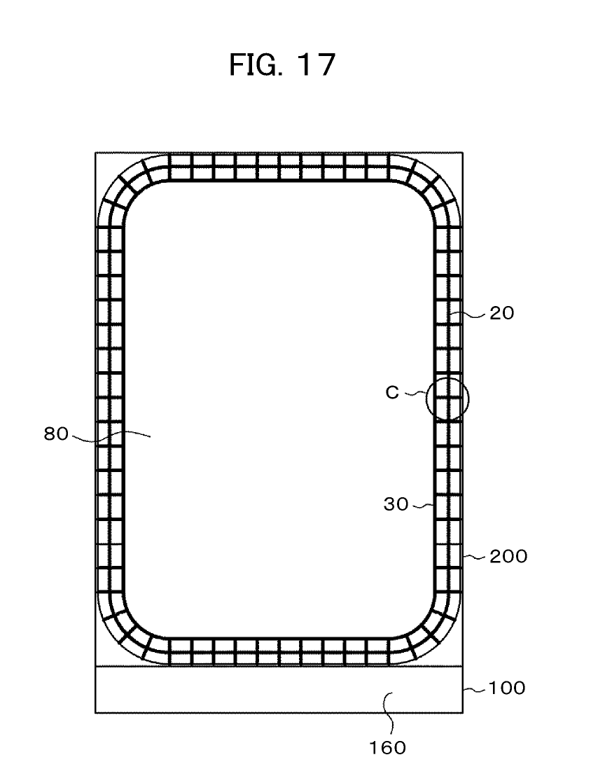

FIG. 17 is a schematic plan view showing a liquid crystal display device according to a third embodiment of the present invention. FIG. 17 differs from FIG. 3 in the first embodiment in that not the T-shaped projection 10 but an H-shaped projection 30 is formed in the peripheral part on the counter substrate 200's side. On the TFT substrate 100's side, the frame-shaped projection 20 is formed in parallel with each side of the TFT substrate 100 to cross the center of a bridge part of the H-shaped projection 30. The frame-shaped projection 20 is equivalent to that in the first embodiment. The H-shaped projection 30 is in contact with the frame-shaped projection 20 at the bridge part.

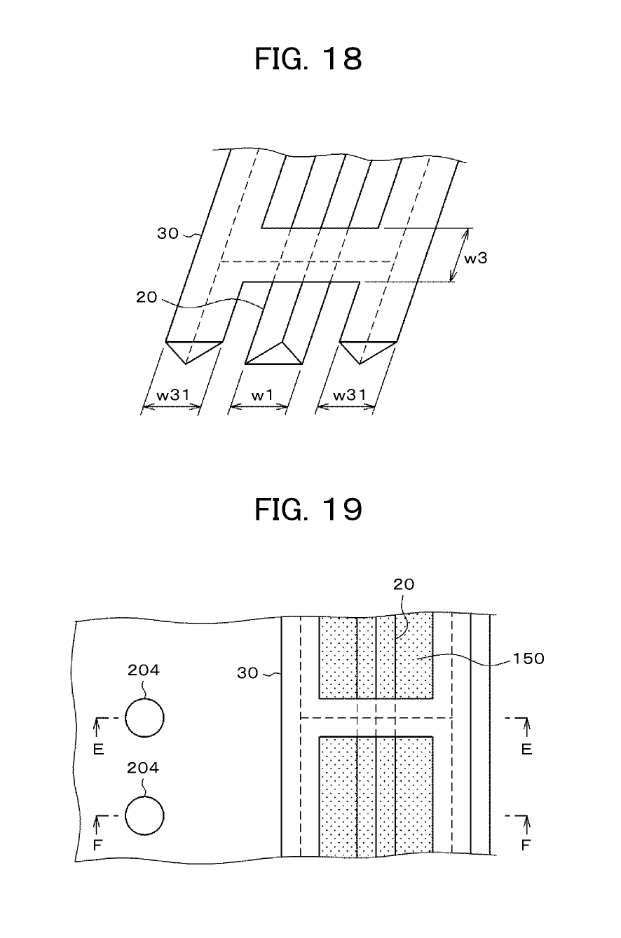

FIG. 18 is a perspective view of the part C in FIG. 17. Illustration of the seal member is omitted in FIG. 18. In FIG. 18, the cross sections of the H-shaped projection 30 are triangles whose top apices are situated on the lower side. The top apex of the triangle as the cross section of the frame-shaped projection 20 formed on the TFT substrate 100 is in contact with the bridge part of the H-shaped projection 30. In FIG. 18, the width w31 of a part of the H-shaped projection 30 parallel to the side of the counter substrate 200, the width w3 of the bridge part of the H-shaped projection 30, and the width w2 of the frame-shaped projection 20 are all approximately 15 μm. The heights of the H-shaped projection 30 and the frame-shaped projection 20 are equivalent to those of the T-shaped projection 10 and the frame-shaped projection 20 in the first embodiment.

FIG. 19 is a plan view of the part C in FIG. 17. In FIG. 19, the seal member 150 is arranged in an internal region of the H-shaped projection 30. The dot line as the center line of the H-shaped projection 30 in FIG. 19 indicates the triangular cross section's top apex existing on the back side. The top apex of the frame-shaped projection 20 formed on the TFT substrate 100 is in contact with the top apex of the H-shaped projection 30 approximately at the center of the bridge part of the H-shaped projection 30.

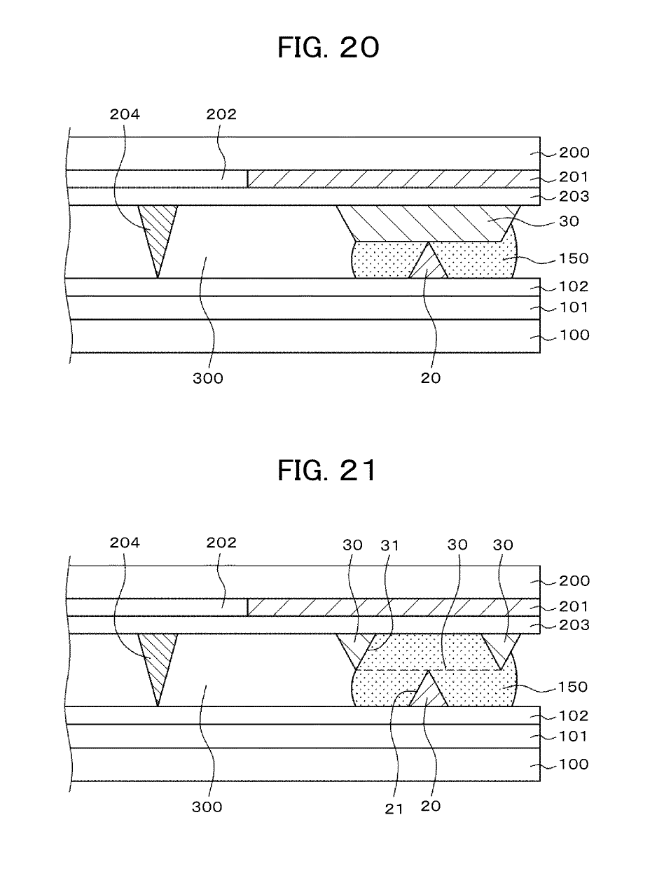

FIG. 20 is a cross-sectional view taken along the line E-E in FIG. 19. In FIG. 20, the bridge part of the H-shaped projection 30 formed on the counter substrate 200 is in contact with the frame-shaped projection 20 formed on the TFT substrate 100, by which the distance between the TFT substrate 100 and the counter substrate 200 is maintained. The rest of the configuration in FIG. 20 is equivalent to that in FIG. 6 of the first embodiment.

FIG. 21 is a cross-sectional view taken along the line F-F in FIG. 19. The dot line of the H-shaped projection 30 in FIG. 21 indicates that the bridge part of the H-shaped projection 30 lies behind the illustrated part of the seal member 150. In FIG. 21, the top apex of the frame-shaped projection 20 formed on the TFT substrate 100 is in contact with the H-shaped projection 30. In FIG. 21, the area of adhesion of the seal member 150 is increased at slopes 31 of the triangular cross sections of the H-shaped projection 30 formed on the counter substrate 200 and at the slopes 21 of the triangular cross section of the frame-shaped projection 20 formed on the TFT substrate 100, and thus the adhesivity increases and the reliability of the seal part can be improved.

While the above first through third embodiments have been described assuming that each of the T-shaped projection, the frame-shaped projection and the H-shaped projection is formed throughout the periphery of the TFT substrate or the counter substrate, the configuration of each projection is not limited to these examples. Similar effects can be achieved even if the projections are formed intermittently along each side of the substrate. It is also possible to form the projections only at positions corresponding to corner parts of the substrates where the control of the seal member width, etc. is relatively difficult.

Further, the configuration forming the T-shaped projection or the H-shaped projection on the TFT substrate's side and forming the frame-shaped projection on the counter substrate's side may also be employed in the present invention as explained referring to FIGS. 9A and 9B.

What is claimed is:

1. A liquid crystal display device comprising
a first substrate and a second substrate bonded to each other at their peripheral parts by using a seal member, and
a liquid crystal sealed up in a space between the first substrate and the second substrate, wherein:
the first substrate has a first projection in which a first part extending along a side of the first substrate in the peripheral part of the first substrate and a second part extending from the first part towards an edge of the first substrate are formed,
width of a cross section of the first projection is smaller on its tip end's side than on the first substrate's side,
the second substrate has a second projection extending along a side of the second substrate in the peripheral part of the second substrate,
width of a cross section of the second projection is smaller on its tip end's side than on the second substrate's side,
the second part of the first projection faces the second projection, and
the seal member exists between the first projection and the second projection.

2. The liquid crystal display device according to claim 1, wherein the cross section of the first projection and the cross section of the second projection are in triangular shapes.

3. The liquid crystal display device according to claim 1, wherein the cross section of the first projection and the cross section of the second projection are in trapezoidal shapes.

4. The liquid crystal display device according to claim 1, wherein the cross section of the first projection and the cross section of the second projection are in tongue-like shapes.

5. The liquid crystal display device according to claim 1, wherein:
the first substrate has columnar spacers determining distance between the first substrate and the second substrate in a display region, and
the first projection is formed with the same material as the columnar spacers.

6. The liquid crystal display device according to claim 1, wherein the second substrate is a TFT substrate having TFTs, video signal lines and scan lines.

7. The liquid crystal display device according to claim 6, wherein:
the second substrate has an organic passivation film covering the TFTs, and
the second projection is formed with the same material as the organic passivation film.

8. The liquid crystal display device according to claim 1, wherein:
the first projection is formed throughout the periphery of the first substrate to extend along sides of the first substrate, and
the second projection is formed throughout the periphery of the second substrate to extend along sides of the second substrate.

9. The liquid crystal display device according to claim 1, wherein distance between the first substrate and the second substrate is determined by the first projection and the second projection.
